(19) United States
(12) Patent Application Publication
(10) Pub. No.: US 2006/0208022 A1
(43) Pub. Date: Sep. 21, 2006

(54) LOAD CARRIER FOOT

(75) Inventor: Peter Karlsson, Gnosjo (SE)

Correspondence Address: NOVAK DRUCE & QUIGG, LLP, 1300 EYE STREET NW, 400 EAST TOWER, WASHINGTON, DC, 20005, US

(73) Assignee: THULE SWEDEN AB, Hillerstorp (SE)

(21) Appl. No.: 11/279,727

(22) Filed: Apr. 13, 2006

Related U.S. Application Data
(63) Continuation-in-part of application No. PCT/SE04/01452, filed on Oct. 12, 2004.

(30) Foreign Application Priority Data
Oct. 13, 2003 (SE) 0302690-3

(51) Int. Cl. B60R 9/00

(52) U.S. Cl. 224/325; 224/315

(57) ABSTRACT

Load carrier foot (5) for connecting a load carrier bar (4) to an, at a vehicle connected, elongated rail profile (3), having in the longitudinal direction (L) of the rail an extended cavity (6), with an upwards turned opening (7), in which the width (B) of the cavity across the longitudinal direction of the rail exceeding the width (b) of the opening, whereby the cavity on each side of the opening having walls (10, 11), which are directed essentially downwards against the bottom (9) of the cavity, whereby the load carrier foot having a base part (13), which extends through the opening towards the bottom of the cavity. A fastening device (29), which by means of a clamping device (51) is moved upwards to clamping contact with the downwards directed walls (10, 11) when the base part being secured to the rail profile. A connection means (25,30) is firmly connected with the locking device (29) and turnable connected to the base part (13), and an elastic body (24) is located between the base part and the connection means, which turns the connection means and the locking device to a position in which the locking device being located transverse relative the longitudinal direction of the rail profile when the base part is mounted to the cavity, and in which position the locking device certainly will be in contact with the downwards directed walls (10, 11) when the locking device being clamped against the walls by the clamping device (51).

### TECHNICAL FIELD OF THE INVENTION

The present invention relates to a load carrier foot for connecting a load carrier bar to a vehicle with an elongated rail profile, having in the longitudinal direction of the rail an extending cavity, with an upwards-turned opening, in which the width of the cavity across the longitudinal direction of the rail exceeds the width of the opening, whereby the cavity on each side of the opening includes walls, which are directed essentially downwards against the bottom of the cavity, wherein the load carrier foot having a base part, which extends through the opening towards the bottom of the cavity and comprising a fastening device, which by a clamping device is moved upwards to a clamping connection with the downwards-directed walls when the base part is secured to the rail profile.

### BACKGROUND OF THE INVENTION

Load carrier feet are previously known. The disadvantage with these previously-known load carrier feet is that the locking device can fail to be properly engaged when being fastened against the walls, whereby an unsafe connection of the load carrier foot to the rail profile is created. When the locking device is located within the cavity it may not be possible to determine if the locking device is in an incorrect, unsecured position. Further, it may not be possible to determine from outside of the cavity whether the locking device is in an incorrect, unsecured position, therefore determining if a safe connection of the load carrier foot to the rail has been made is difficult.

Thus, there is a need of a load carrier foot in which the locking device always ends up in a position in which the locking device is secured against the walls and which may be actuated in position from the outside of the rail profile, and is connected with an indication device, which may be observed from the outside of the rail profile and which easily discloses in which position the locking device is within the rail profile.

### SUMMARY OF THE INVENTION

One object of the present invention is to provide a load carrier foot which includes a connection part that is firmly secured to the locking device and rotatably connected to the base part, and a resilient member that is located between the base part and the connection part, which rotates the connection part and the locking device to a position in which the locking device, being located transversely, relative to the longitudinal direction of the rail profile when the base part is mounted to the cavity, and in which position the locking device is in contact with the downward-directed walls, when the locking device is clamped against the walls by the clamping device.

At least one embodiment of the present invention includes a connection part having a control arm, which is placed on the side of the base part that is located on the outside of the cavity of the rail profile.

In addition, the present invention includes a controlling arm that is located in an indicator position, where the locking device has been moved by the resilient body to the position in which it will safely be in engagement with the walls when secured by the securing device.

In addition, the present invention includes a resilient device that may be a torsion spring.

Further, the present invention includes a connection part in which the controlling arm may be twisted against the force from the resilient body, from the indicator position to a second position in which the locking device extends in essentially same direction as the base part.

### BRIEF DESCRIPTION OF THE DRAWINGS

The invention is described in greater detail with reference to illustrative embodiments shown in the accompanying drawings, in which:

FIG. 1 is an overall view of a vehicle with load carrier rods connected to the rail profile, with load carrier feet according to an embodiment of the present invention;

FIG. 2 is a detailed view of a load carrier foot according to an embodiment of the present invention connected to a rail profile and in which figure an outer exterior cover, which covers the interior of the foot, has been omitted;

FIG. 3 is an exploded view of the load carrier foot shown in FIG. 2, in which the load carrier bar has been omitted.

FIG. 4 is an exploded view in which the base part of the load carrier foot, the connection part and the tightening plate are shown in detail and viewed from below the base part;

FIG. 5 is a detailed view of the base part mounted to a rail profile, in which the operating arm is located in its indicator position;

FIG. 6 is a view corresponding to FIG. 5, in which the operating arm is shown at a second position;

FIG. 7 is a view corresponding to FIG. 5, viewed from below and with the rail profile omitted;

FIG. 8 is a view corresponding to FIG. 6, viewed from below and with the rail profile omitted;

FIG. 9 is a view corresponding to FIG. 5, viewed from the position that is indicated with the arrow “S” in FIG. 5; and

FIG. 10 is a view corresponding to FIG. 6, viewed from the position that is indicated with the arrow “T” in FIG. 6.

### DETAILED DESCRIPTION

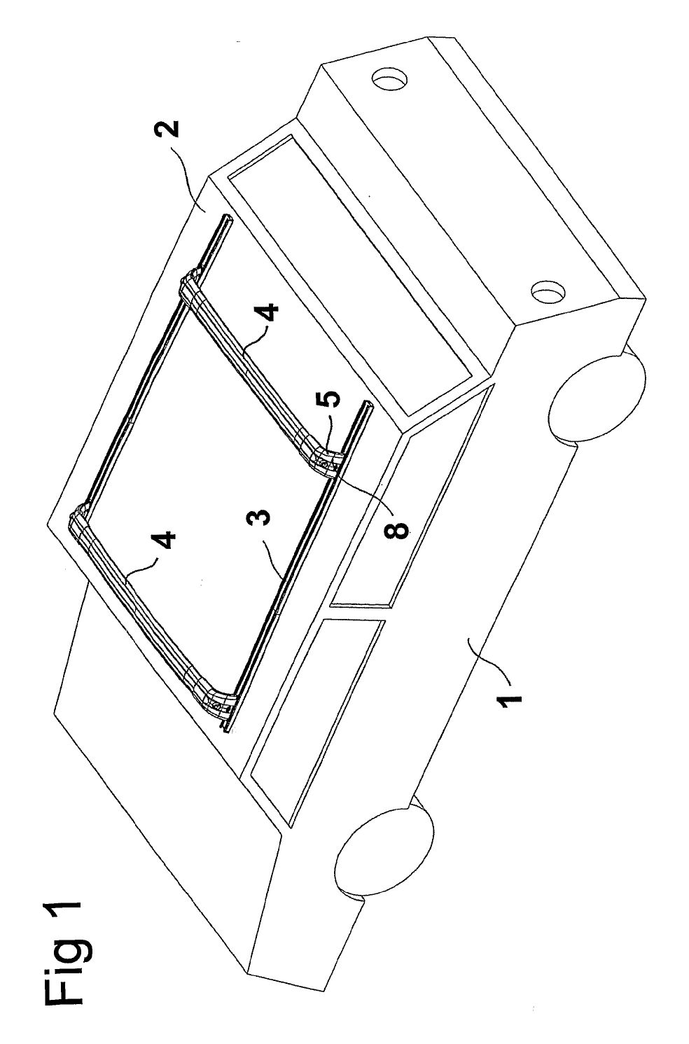

With reference to FIG. 1, vehicle 1 is shown with elongated rail profiles 3 connected to roof 2, and to which load carrier rods 4 provided with load carrier feet 5 according to an embodiment of the present invention are mounted.

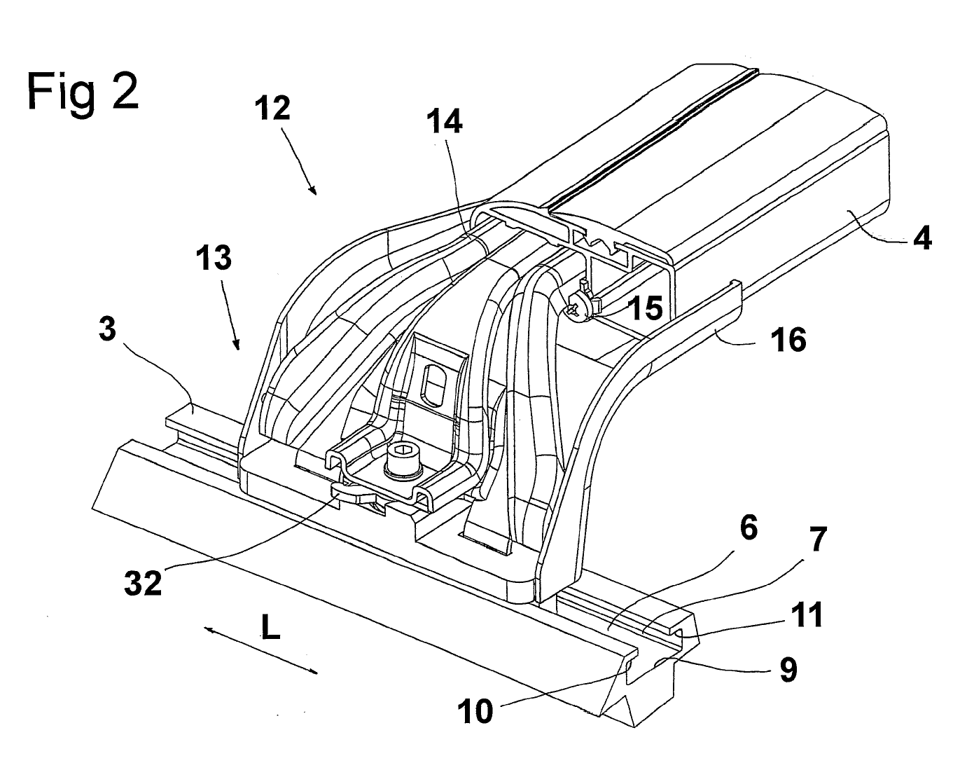

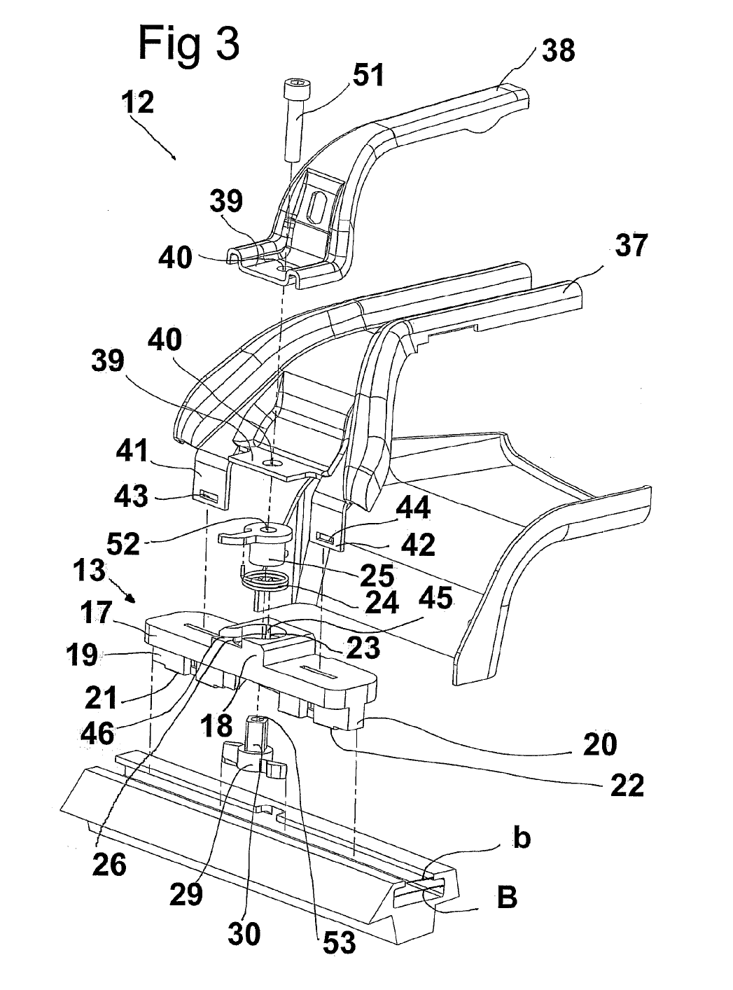

FIG. 2 discloses a portion of rail profile 3, which longitudinal direction has been indicated with the double arrow “L” and to which load carrier foot 5 is mounted. The rail profile has cavity 6, with an upwards-turned opening 7, and in FIG. 3 the width of the cavity is indicated by “B” and the width of the opening by “b”. As shown in the figure the width of the cavities is larger than the width of the opening. Cover 8 which covers the inner part of the foot and which is shown in FIG. 1, a function of which is to provide an attractive exterior, is omitted in the figure. Bottom 9 of cavity 6 is shown and the walls of the cavity, located adjacent to the opening, designated 10 and 11 respectively, and as shown, are directed essentially downwards against bottom 9 of the cavity. The load carrier foot comprises frame part 12 and base part 13. The frame part has an upper end 14 connected to load carrier bar 4 with bolts 15, of which only one is shown in the figure. Base part 13 is mounted to the rail profile, as will appear from below. Also, cover 16 appears in the figure, which is located on the inside of base part 13 and which extends between the base part and load carrier bar, and a function of which is, in the same manner as cover 8, to make a attractive exterior.

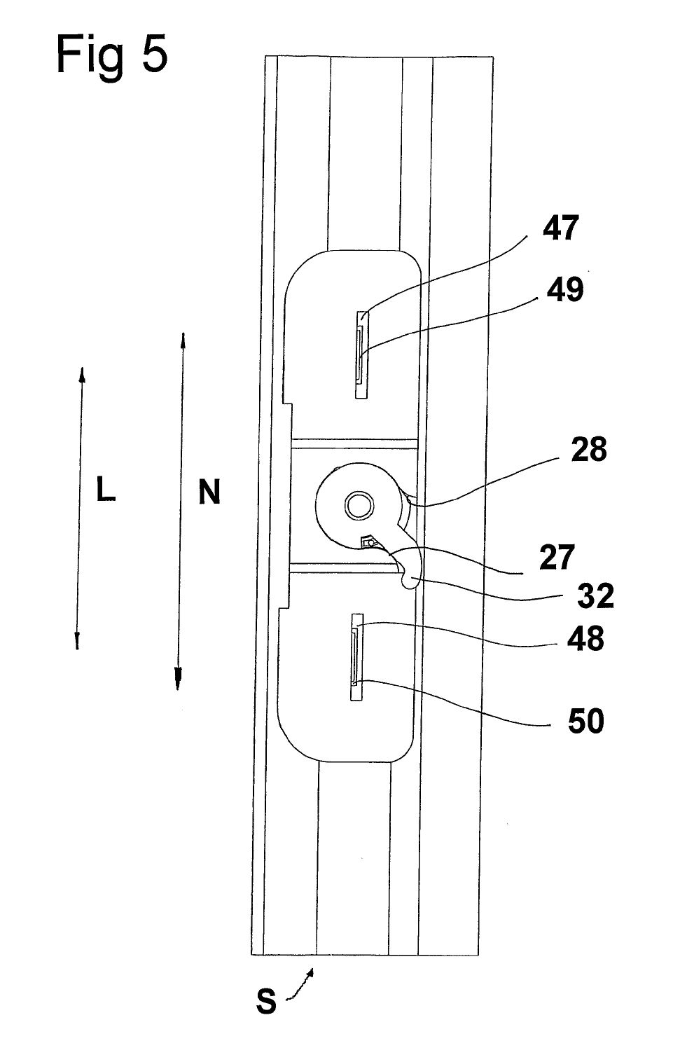

FIG. 3 is an exploded view of the load carrier foot shown in FIG. 2, but with load carrier bar 4 omitted. In the figure, base part 13 is shown, which comprises flat part 17, having a centrally located block 18. Support shoulders 19, 20 are arranged on the underside of part 17, which has a respective abutting surface 21, 22 whose function will be explained below. Cylindrical hole 23 extends through block 18, in which a resilient body in form of torsion spring 24 together with cylinder 25 are mounted. In block 18, an opening 26 is formed, which extends into hole 23. The opening is defined by first end surface 27 and second end surface 28, which surfaces are shown in FIG. 5. Below part 17, fastening device 29 is shown, which is firmly connected to shaft 30, having a non-circular cross section. The shaft is connected to cylinder 25.

With further reference to FIG. 3, frame part 12 is shown, including first bracket part 37 and second bracket part 38, of which the second part is firmly connected to the first the part, when the frame part is mounted to the base part. The connection of the second part to the first part may happen by welding, riveting, soldering or on every other suitable way. To the frame part is further arranged first tab 39, through which is formed hole 40, second tab 41 and third tab 42, which have a respective hatch 43, 44.

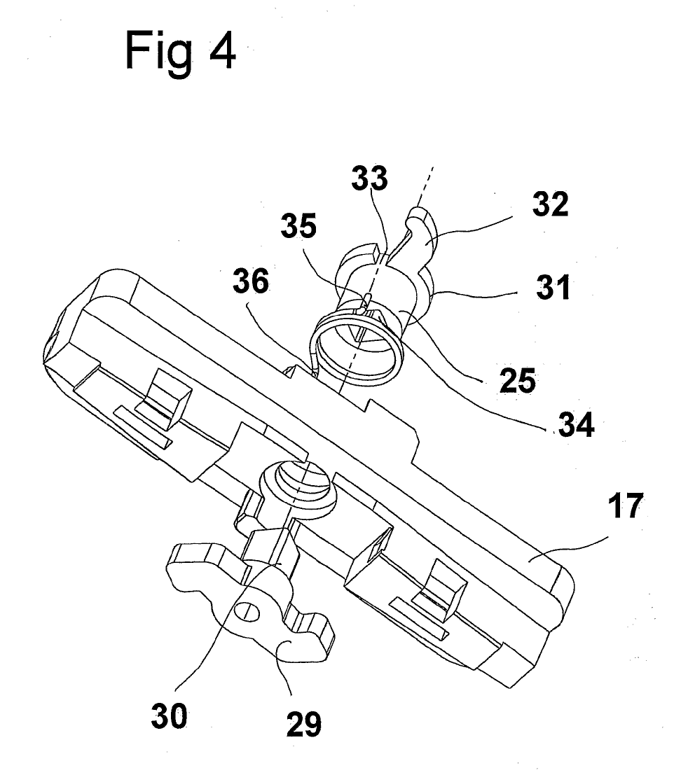

In FIG. 4, the base part and fastening device is viewed from below. Cylinder 25, in its upper area, having flange 31 to which arm 32 is connected and notch 33 is formed in flange 31. Further, in the cylinder is recess 34 is shown, having a non-circular cross section. From the figures, torsion spring 24 is also shown, which has first connecting pin 35 and second connecting pin 36.

With reference to FIGS. 3 and 4, the assembly of the load carrying foot of the embodiment shown in FIG. 2 will be described. Torsion spring 24 is mounted to cylinder 25 and first connecting pin 35 is mounted in notch 33. The cylinder with the torsion spring is moved into the through hole 23 and second connecting pin 36 is mounted to notch 45, formed in the circumferential surface of hole 23. The cylinder is moved downwards into hole 23, so that arm 32 is able to contact with bottom surface 46 of openings 26. Thereafter, second and the third tab, 41 and 42, respectively, are mounted into recesses 47 and 48, respectively, formed in plate 17, and in connection to that first tab 39 is located over cylinder 25, whereby ensuring that the cylinder being held on place in hole 23. Tabs 41 and 42, respectively, are connected firmly to recesses 47 and 48, respectively, through that hatches 43 and 44 will be in engagement with knobs 49 and 50, respectively, arranged in recesses 47 and 48, see FIG. 5. Finally shaft 30 is located on fastening device 29 in opening 34, and bolt 51 is moved through hole 40 and hole 52, formed in shaft 25, to connect with threaded hole 53 in the shaft, whereby the locking device over the shaft and the cylinder become turnably connected to the base part and with bolt 51 tightly connected to the base part.

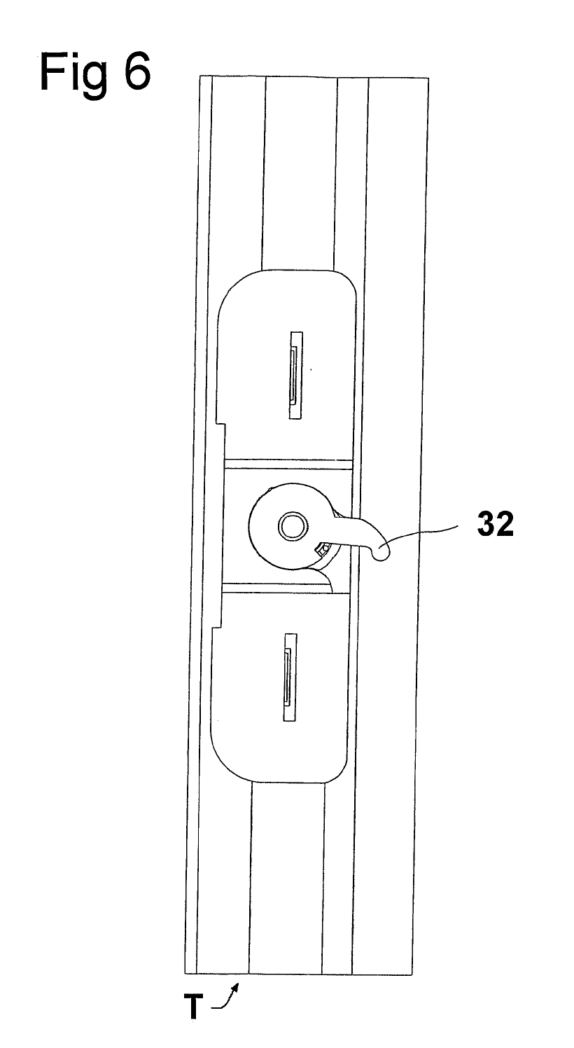

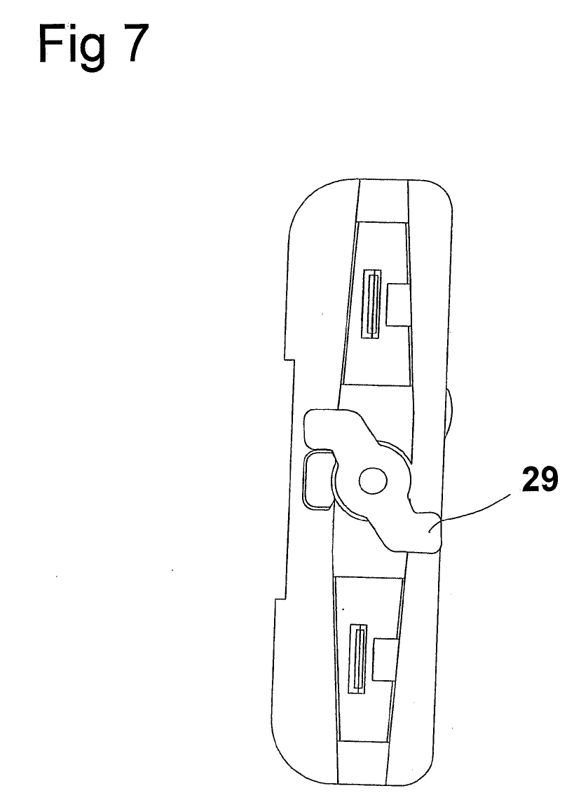

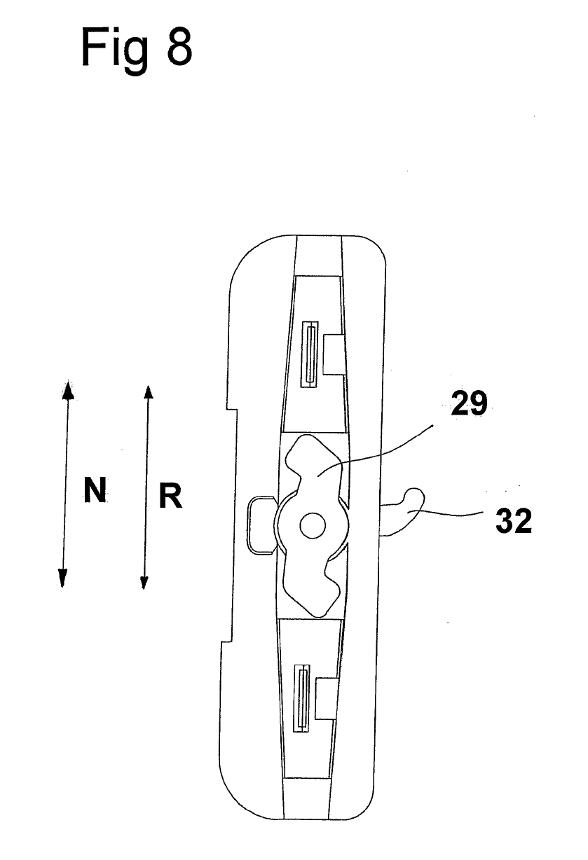

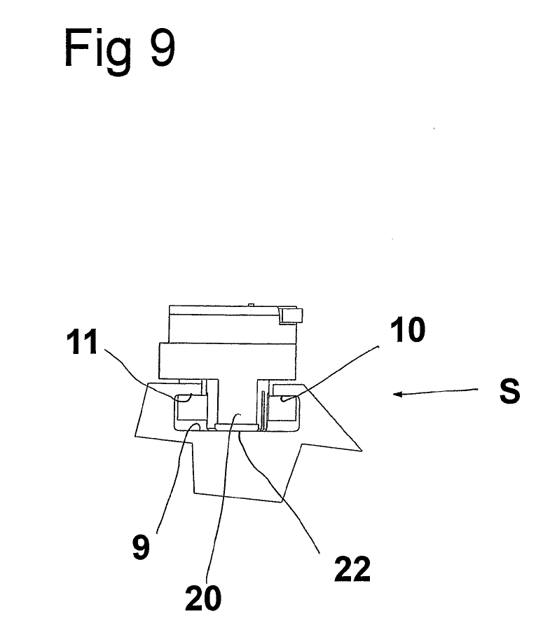

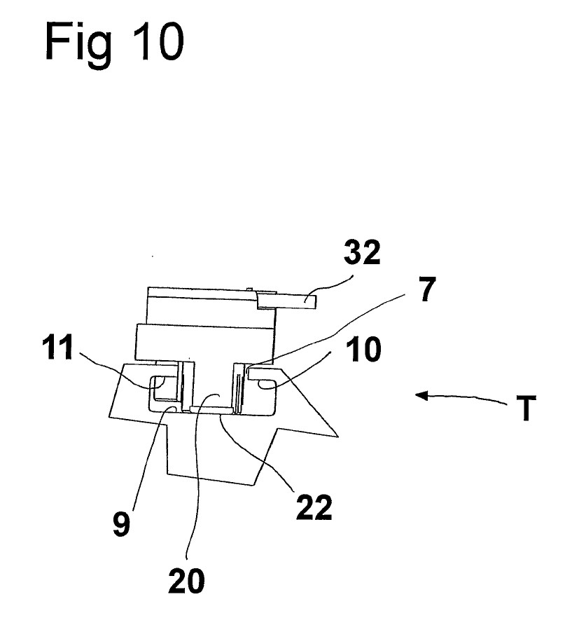

With reference to FIGS. 5-10, the function of the base part is described. When the load carrier foot is mounted to the rail profile, arm 32 is turned against the force of torsion spring 24 to the position shown in FIG. 6. In this position, the locking device occupies the position that is shown in FIG. 8. The longitudinal direction of the locking device is indicated with the double arrow “R” and the longitudinal direction of the base part being indicated with the double arrow “N”. As shown in FIGS. 5 and 8, in which the longitudinal direction of the rail profile also have been indicated, the direction “L” and “N” are parallel, and in the position that is shown in FIG. 8, the locking device thus extends in a parallel direction to the rail profile, and the base part may be mounted to the rail profile. When the base part has been mounted to the rail profile, support shoulders 19 and 20 extend through opening 7 of rail and contact surfaces 21 and 22 are located on the bottom of rail 9. Thereafter, arm 32 is released and the torsion spring moves the arm to the position it shown in FIG. 5. In this position the locking device occupies a transverse position relative the longitudinal direction “L”, which is shown in FIG. 7, and in this position the locking device is located such that it extends below the downwards-directed walls 10 and 11, which are shown in FIG. 9. Thereafter, the locking device is moved in direction against walls 10 and 11 of bolt 51, whereby the base part is pressed downwards against the bottom of rail 9, whereby the base part become firmly connected to the rail profile.

With reference to FIGS. 2 and 5, it is shown that arm 32 is located in a certain position, which is viewable from the outside of the rail profile, and in this position also the locking device is in a position in which it is in engagement with the walls. If the arm should be located in the position shown in FIG. 6, the user will know that the locking device is not secured and by moving the arm to the position shown in FIG. 2, assuring oneself that the locking device is in correct position. Thus, arm 32 functions as an indicator element and in the indicator position, shown in FIGS. 2 and 5, indicates that the locking device is in the correct position, while in other positions the locking device is misplaced and may be secured by moving arm 32 to the correct position.

The invention shall not be deemed to be limited to the illustrative embodiments described above. Instead, a number of further variants and modifications are conceivable and with the scope of the patent claims.

What is claimed is:

1. Load carrier foot (5) for connecting a load carrier bar (4) to an, at a vehicle (1) connected, elongated rail profile (3), having in the longitudinal direction (L) of the rail an extended cavity (6), with an upwards turned opening (7), in which the width (B) of the cavity across the longitudinal direction of the rail exceeding the width (b) of the opening, whereby the cavity on each side of the opening having walls (10, 11), which are directed essentially downwards against the bottom (9) of the cavity, whereby the load carrier foot having a base part (13), which extends through the opening towards the bottom of the cavity, and comprising a fastening device (29) which by means of a clamping device (51) is moved upwards to clamping contact with de downwards directed walls when the base part being secured to the rail profile, wherein a connection means (25,30) is firmly connected with the locking device (29) and turnable connected to the base part (13), and in that an elastic body (24) is located between the base part and the connection means, which turns the connection means and the locking device to a position in which the locking device being located transverse relative to the longitudinal direction (FIG. 7) of the rail profile when the base part is mounted to the cavity, and in which position the locking device certainly will be in contact with the downwards directed walls (10, 11) when the locking device by the clamping device (51) being clamped against the walls.

2. Load carrier foot according to claim 1, wherein the connection means (25,30) having a controlling arm (32) which is located on the side of the base part that is located outside the cavity of the rail profiles.

3. Load carrier foot according to claim 2, wherein the controlling arm (32) is located in a indicating position (FIG. 2) when the locking device (29) being moved by the elastic body (24) to the position in which it certainly will be in engagement with the walls, when being clamped by the clamping device.

4. Load carrier foot according to claim 1, wherein in that the elastic the device consist of a torsion spring (24).

5. Load carrier foot according to claim 1, wherein the connection means (25,30) with the controlling arm (32) may twisted against the force from the elastic body (24) from the position of indication to a second position (FIG. 8) in which the locking device extends essentially in the same direction as the base part, wherein the base part may be moved in and out of the opening of the rail profile.
